(19) United States
(12) Patent Application Publication
(10) Pub. No.: US 2026/0087323 A1
(43) Pub. Date: Mar. 26, 2026

(54) Architecture for conscious artificial intelligence

(71) Applicant: Timothy Bult, Milwaukee, WI (US)

(72) Inventor: Timothy Bult, Milwaukee, WI (US)

(21) Appl. No.: 18/892,360

(22) Filed: Sep. 21, 2024

(51) Int. Cl. G06N 3/0475; G06N 3/0455; G06N 3/08

(52) U.S. Cl. CPC G06N 3/0475; G06N 3/0455; G06N 3/08

(57) ABSTRACT

This invention is a unique architecture for creating an Artificial Intelligence (AI), using generative AI Large Language Models (LLMs) as components in a particular arrangement based on recent psychology and neurology research. Specifically, from psychology it distinguishes the subconscious LLM processing from the conscious cycle of reviewing and evaluation subconscious thoughts, according to “value judgments,” which also use LLMs as embodying human value judgments. From neurology it applies the ANCCR algorithm for retraining the subconscious nets, rather than the mix of forward and propagation common to current deep learning networks.

### REFERENCE TO RELATED APPLICATIONS

Provisional application No. 63/591,605, filed Oct. 19, 2023.

### BACKGROUND OF THE INVENTION

Consider this thought experiment. Imagine you've become a telepath. You have a new sense that let's you look inside someone's mind. You can “see” their every conscious thought, sense their every feeling, see what they see, hear what they hear. You are the watcher of their mind as much as they themselves are. Perhaps some of their thoughts will surprise you, but the basic flow of thoughts and sensations in their mind, the chatter of the typical human being, will seem familiar to you. You will probably agree that they are a conscious being, since you can see their consciousness.

Now, although you've been reading their mind for a while, you learn that they are not a human being after all. They are an Artificial Intelligence (AI), resident in the cloud. With this new information, do you believe they are conscious? Do they have a mind? And, given the resources of the entire computing cloud, are they more likely to be smarter than the average human?

We argue that the architecture proposed here is uniquely effective, both to improve AI, and to explain the human mind. Note that by “conscious AI” we are not discussing the philosophical question of whether a computer can have subjective experience, what David Chalmers called the “hard problem” of AI. We are discussing the engineering question: how are the conscious processes of the mind structured, in enough detail to build an AI that can effectively do the same things a conscious human mind can do.

AI research has often devised computational models of various aspects of human thought. For example, in the 1970s and 80s the MIT Vision Lab built extensively validated explanations of how the human brain processes signals from the eyes to create vision. One very successful model in this paradigm was the development of neural networks to simulate basic brain function, a model that is behind most of today's commercial deep learning AI, including recent Large Language Models (LLMs) like ChatGPT. Ironically, research published in 2022 has upended the basic learning algorithm used for decades (mixing forward and backward propagation) with strong evidence the human brain uses a different “retrospective causal learning” approach (Jeong et al, “Mesolimbic dopamine release conveys causal associations”, Science, Dec. 8, 2022). This has not yet been applied to AI architectures.

In this document we lay out a computational model for human or AI consciousness. It builds on several research platforms that have emerged in recent decades: Large Language Models (LLMs) as a basis for subconscious thought, the Global Neuronal Workspace (GNW) model as a basis for understanding conscious thought, and the Tree of Thoughts (ToT) theory for exploiting LLMs more effectively. In 2011 Dehaene and Changeux published “Experimental and theoretical approaches to conscious processing” in the journal Neuron, focused on how well GNW explains human brain activity given experimental data. We carry their theory a step further to building a conscious computer. One interesting point they make is that there is a clear, strong threshold in human thought, between stimulus being consciously perceived or not: “those data suggest that conscious access causes a major change in the global availability of information, whether queried by objective or by subjective means.” They also explore changes from the unconscious to conscious state, such as what kind of pattern or stimulus can lead to “ignition.” They describe extensive evidence that brain neurons are wired consistently with this model of consciousness.

Where Dehaene and Changeux appeared interested primarily in how well their model matches human consciousness, this proposal is equally interested in how we can build an Artificial General Intelligence (AGI), with finding a computational model of consciousness, somewhat like studying how birds fly in order to build an airplane. Here is what we mean by a computational model. We describe a set of structures and processes, in enough detail that a team of software engineers can build a software system realizing them, which would run in ways that can be verified as meeting the goals of the model. For example, early models of computer vision algorithms were implemented as computer programs, and the results compared against nerve signals in the brain, verifying that the models accurately represented how the brain works.

This is harder for more complex brain functions, but paradoxically may be feasible today for conscious thought, because conscious thought is to a large extent accessible through introspection and communication. If we aren't aware of it, by definition it isn't consciousness, and if we are aware of and able to communicate something, it is consciousness by definition.

This does not mean consciousness is trivially simple. It is subtle, and dependent on less transparent, more complex subconscious processes. It is plentifully written and talked about, but how sure are we about the commonality and differences between different people's consciousness? This paper attempts to explain the mechanisms of consciousness that are shared across human beings, as a model for building a more effective AGI.

The proposal can also be thought of as extending the “Tree-of-Thought” approach created by Google Deepmind researchers, which generalizes LLMs by building a reasoning algorithm incorporating LLMs as components (“Tree of Thoughts: Deliberate Problem Solving with Large Language Models”—forthcoming, available in pre-print). ToT theory suggests using an LLM both to generate nodes in a search tree, and to evaluate them, then using a search algorithm to proceed through the search tree. Our variation is to use a particular structure, and search algorithm suggested by human cognition research, and to train the evaluation nets in a particular way to reflect human values.

While it may be inevitable that other researchers eventually develop along these same lines, we have done a fairly intensive survey of the state of the art in AGI as of Summer 2024, and have not come across a project doing any of the following, which we believe will yield better AGI, expanded later as the formal claims of this patent application.

### FIELD OF THE INVENTION

USPC 706/62: this application falls under classification 706 Data processing: artificial intelligence. As none of the other subclasses align with our scope, we address subclass 62 Miscellaneous.

### PRIOR ART

To support the Patent Application, and also to validate the engineering and business approach of our venture, this section attempts to summarize the state of the art in Artificial General Intelligence (AGI) as of Summer 2024. While this is now an enormous field with billions of dollars being spent on R&D, much of that effort is focused on the particular technology of Large Language Models (LLMs). This paper includes LLMs, but also other architectures for achieving AGI, to help put our own architecture into context.

This survey is based on the following searches and articles . . . .

Use of the US Patent Office website, with multiple variations of key terms expected to be used in related patents. For example, search for “AGI” (operator-AND) “Intelligence” yielded 339 records, although most are completely unrelated to AI. Similarly, a search for “Conscious” and “AI” yielded 4226, of which only 11 are competing proposals for conscious AI. These 11 are discussed below.

Review of Stanford's 2021 Study Panel Report on AI, as well as the “Stanford Emerging Technology Review 2023” (whose first section was on AI—focused almost exclusively on LLMs).

Similar search on Google as done at the Patent Office, to find both formally and informally published papers.

Conversations with CTOs, CEOs, and founders of several AI companies, which led to recommendations on particular papers, companies, and approaches to compare ours to. For example, this led to the Tree-of-Thoughts Google Deep Mind article not yet formally published, but available on a public archive.

Google Scholar for targeted search of academic publications.

“Approaches to Artificial General Intelligence: An Analysis” by Soumil Rathi.

https://en.wikipedia.org/wiki/List_of_artificial_intelligence_projects.

The following keywords were used, in various and/or combinations, for the searches listed above:
AGI
AI
Conscious
Intelligence
Architecture
Framework
Approach
Computational Intelligence

We are concerned with approaches to building Artificial General Intelligence (AGI). This means setting aside Artificial Intelligence (AI) techniques focused on specific narrow aspects of intelligence, such as Computer Vision, Natural Language Processing, game-playing (Chess, Checkers, Go), and robotic control. We are also not concerned here with philosophical arguments about the nature of intelligence, the nature of consciousness, or Searle's distinction between “strong” and “weak” AI. We take as given a reasonable understanding of “general intelligence” where human beings are the standard of performance. One has achieved AGI if the AGI can meet or exceed human abilities across an arbitrary range of behaviors or intellectual challenges.

According to Stanford, the global AI market received $136.55 billion in 2022. Such a broad field is impossible to comprehensively cover in any one effort or document of reasonable size. We hope at least to be representative of the most important attempts, and to find any that border on our proposed approach. To help organize their presentation, we group them in subsections, one for each major category.

### Large Language Models

ChatGPT has made Large Language Models (LLMs) widely known, and their success at a wide range of tasks has led to discussion of “how intelligent” they can be, whether they of themselves can achieve AGI. An LLM might be defined as a transformer-based deep learning network trained on a large corpus of text. That makes them an important subset of neural networks in general, which have steadily grown in size and sophistication since their invention in the 1940s. The largest investments in AGI today are in methods to improve LLMs such that a better LLM can achieve AGI on its own. Other sections of this survey will look at alternatives to LLMs, or architectures where LLMs are but a component, but here we'll list some of the key approaches to LLM improvement:

Deep Reinforcement Learning (RL): Used by Google DeepMind, along with other techniques, to develop AlphaGo, which beat Lee Sedol, one of the world's best Go players. Unlike Supervised Learning, RL gets its feedback automatically from rules as it interacts with its environment. The reward signal for game-playing may be simple win/loss, but more complex signals can be used for more general learning. This is one of the largest areas of investment in AI today, with variations on RL to train nets for more general robustness (ie. AGI).

RLHF (Reinforcement Learning from Human Feedback). This was reportedly crucial to OpenAI's success in improving ChatGPT: https://openai.com/research/instruction-following. OpenAI's paper says ChatGPT's performance was improved more by RLHF than by a factor 100× in the size of model. Similarly, Mistral AI has achieved better LLM results through careful training, for smaller models.

Larger models. Although better training certainly yields a better LLM for the same size, bigger models also help. While introduction of the transformer in 2017 (https://proceedings.neurips.cc/paper/2017/file/3f5ee243547dee91fbd053c1c4a845aa-Paper.pdf) is seen as the “beginning” of LLMs, a cynic might say the biggest difference between the first Perceptrons of the 1960s (https://en.wikipedia.org/wiki/Perceptron) and GPT4 is the computing power of 400 nodes vs. 1 billion. OpenAI CEO Sam Altman's efforts to have the world develop more AI chips implies ongoing investment to make even larger models, eventually exceeding the node-count of the human brain (approximately 100 billion neurons). It is possible that simply making a large enough LLM, with appropriate training, will lead to AGI, as in effect this may be what evolution did to create the human brain. But this may not be the only, or the most efficient, way to get there.

Control vectors. https://vgel.me/posts/representation-engineering/. One AI entrepreneur thought the already-published concept of “control vectors” might be analogous to the “value nets” in our proposed architecture. Control vectors are an adjustment made to a given trained LLM, where the weights are adjusted based on the result of different prompts . . . so embedding the values of those prompts into the LLM. This is an ingenious way to embed a prompt into an LLM, but it does not allow for multiple values explicitly represented and auditable or memorable or self-learning.

Hidden prompts. One way to improve an LLM's performance is to append a standard “hidden prompt” to any prompt a user provides, with the hidden prompt meant to refine the LLM to behave “well.” A trivial example might be to always append “but don't say anything resembling pornography, or provide any information supporting violence against human beings.” Reddit has many discussions about the hidden prompts in ChatGPT and other LLMs.

“Constitutional AI: Harmlessness from AI Feedback” published December 2022 offers another training paradigm, using a set of high level rules as input, to have one LLM assess the outputs of another LLM, toward training it to better align with the rules.

Google Deepmind now has approximately 2500 staff between the US and UK, pursuing AGI primarily through deep learning models. Other major companies focused on the LLM paradigm include Anthropic (Claude), xAI (Grok), Mistral AI, and of course OpenAI (GPT).

OpenAI Chief Executive Sam Altman has indicated that his company is working on new methods to train future models. “I think we're at the end of the era where it's going to be these giant, giant models, and we'll make them better in other ways.”

Retrieval-Augmented Generation (RAG) was first so named in a Facebook AI paper published in 2020 (https://arxiv.org/pdf/2005.11401.pdf), but the paper acknowledged decades of prior work to supplement generative AI with “retrieval” from factual sources. Superficially, one can think of a RAG approach as doing a fact-check of generative AI's results against Wikipedia (as in the Facebook paper) or some other source of “truth.”

Several AI efforts are now RAG-based. Our proposal for an AGI architecture includes an element of RAG, where the value-net assessing “truthfulness” of a thought may best be implemented with RAG—but our architecture specifies many other components for the complete architecture.

Mixture of Experts: In this section we group a number of techniques being used to combine multiple LLMs, or other forms of neural network, to achieve better AGI.

According to Wikipedia, the first paper applying MoE to deep learning networks was https://arxiv.org/abs/1312.4314, “Learning Factored Representations in a Deep Mixture of Experts” by Eigen, Ranzato, and Suskever, in 2013. That paper describes an architecture with multiple layers, with “gating networks” at each level to help decide which expert network to use for a given prompt.

Google Deepmind has also published articles in this space. A key one is on their “Tree of Thoughts” technique: https://www.nextbigfuture.com/2023/05/tree-of-thoughts-improves-ai-reasoning-and-logic-by-nine-times.html.

There are several claims that MoE is the basis for Mistral AI's success in getting better performance from smaller models, for example https://www.reddit.com/r/agi/comments/lalOtao/is_mixture_of_experts_the_path_to_agi/.

Note that these combine a set of models, or layers of a model, in a predefined way, a fixed structure, to more effectively respond to a given prompt. They do not of themselves include memory, ongoing improvement, or an ongoing activity, other than response to a prompt. They do support some level of explainability for a given conclusion, and have improved on straightforward model size.

Hierarchical Temporal Memory. From Wikipedia: “Hierarchical temporal memory (HTM) is a biologically constrained machine intelligence technology developed by Numenta. Originally described in the 2004 book On Intelligence by Jeff Hawkins with Sandra Blakeslee, HTM is primarily used today for anomaly detection in streaming data. The technology is based on neuroscience and the physiology and interaction of pyramidal neurons in the neocortex of the mammalian (in particular, human) brain. At the core of HTM are learning algorithms that can store, learn, infer, and recall high-order sequences. Unlike most other machine learning methods, HTM constantly learns (in an unsupervised process) time-based patterns in unlabeled data. HTM is robust to noise, and has high capacity (it can learn multiple patterns simultaneously).”

While HTM has apparently been applied in narrow applications only, it is arguably an appropriate learning algorithm for AGI. It was conceived as the learning algorithm for Jeff Hawkins' Thousand Brains Theory of Intelligence, which focuses on applying emerging neuroscience . . . so might be considered a variant of the “brain simulation” approach to AGI.

Common Sense Reasoning. The 2021 Stanford Report on AGI references several ongoing research programs to imbue AI with basic reasoning capabilities, noting that none of these has yet approached human performance, although they are helping better understand human reasoning . . . .

Ernest Davis and Gary Marcus, “Commonsense reasoning and commonsense knowledge in artificial intelligence”, Communications of the ACM, Volume 58, Issue 9, September 2015 pp 92-103.

Lifeng Fan, Siyuan Huang, Mark Edmonds, Hangxin Liu, Feng Gao, Chi Zhang, Siyuan Qi, Ying Nian Wu, Joshua B. Tenenbaum, and Song-Chun Zhu, “Dark, Beyond Deep: A Paradigm Shift to Cognitive AI with Humanlike Common Sense,” https://arxiv.org/abs/2004.09044

Judea Pearl, “Theoretical Impediments to Machine Learning With Seven Sparks from the Causal Revolution,” https://arxiv.org/abs/1801.04016

Kevin A. Smith, Lingjie Mei, Shunyu Yao, Jiajun Wu, Elizabeth Spelke, Joshua B. Tenenbaum, and Tomer D. Ullman, “Modeling Expectation Violation in Intuitive Physics with Coarse Probabilistic Object Representations,” 33rd Conference on Neural Information Processing Systems (http://www.mit.edu/\hat{˜}k2smith/pdf/Smith_et_al-2019-Modeling_Expectation_Violation.pdf)

Melanie Mitchell, “Abstraction and Analogy-Making in Artificial Intelligence,” (https://arxiv.org/abs/2102.10717v2)

### Brain Simulation and Probability Theory

Neural networks, and today's variant on them, LLMs, stemmed originally from simulation of neurons in the human brain. One approach to AGI is to carry such research further, and attempt to simulate larger and larger brain components, or even the entire brain, at a fine-grained level.

In “Approaches to Artificial General Intelligence: An Analysis,” Soumil Rathi reviews some of these approaches. We won't analyze examples here, as their conclusion was that such approaches will require another 10+ years of development. Long term projects in this space include the Blue Brain Project, Google Brain, and the Human Brain Project.

Rathi's paper examines Probability Theory as another approach to AGI, similarly concluding that while mathematically interesting, the approach is not practical, at least for now. Probability theory might provide a framework to understand decisions an AGI might make to maximize certain goals over its lifetime.

### Cognitive Architecture

This is the overall approach that ours fits into: leveraging our understanding of the human mind to create an architecture for AGI. Rathi's survey article (https://arxiv.org/pdf/2202.03153.pdf) divides it into three categories:

Symbolic approaches. A classic example is the Soar project from the 1980s-2010s at CMU and later other universities (https://direct.mit.edu/books/book/2938/The-Soar-Cognitive-Architecture). Soar has long and short term memory including complex representation of spatial relationships, a clock cycle for its reasoning algorithm, and algorithms for reinforcement learning. Soar was applied to various problem domains, but never approached human-level intelligence. Another was “Cyc” which attempted to incrementally gather explicit rules of common sense reasoning to eventually build an AGI.

Emergent approaches. Rathi groups all neural network developments here. Ironically his article pre-dates the release of ChatGPT, and is quite negative about the likelihood of AGI emerging anytime soon from such tools.

Hybrid. Rathi's key example is CogPrime (https://ieeexplore.ieee.org/document/6613266 or https://goertzel.org/papers/CogPrime_Overview_Paper.pdf).

Soar and other purely symbolic approaches may suffer from trying to explicitly develop all reasoning with explicit rules, rather than leveraging automated deep learning. Even the hybrid approaches such as CogPrime struggle with the sheer volume of reasoning that needs to be done for AGI. Adding components for probabilistic reasoning, as CogPrime did, has so far not been enough. This is acknowledged by their research leads, for example in Goertzel's comments on CogPrime in 2012: “we are still struggling to get our AGI systems to deal with basic situations like creative box play”.

CogPrime continues to develop, using an open-source suite called OpenCog. It has a particular architecture combining multiple forms of memory and reasoning, which combines some modeling of the human mind, with technologies from computer science. It has seen 50+ applications or experiments, but like all other AI systems so far, has not claimed to “achieve AGI”.

That said, Ben Goertzel has recently said “It's becoming clear to more and more people, both in the AI field and beyond, that achieving human-level and perhaps even superhuman AGI may be feasible in the relatively near term.”

Here are brief summaries of key published cognitive architecture projects (from those listed on Wikipedia's page of Cognitive Architectures which appear to have continuing efforts):

ACT-R from Carnegie Mellon University claims to be firmly in the “symbolic” camp, as opposed to “connectionist”, although inspired by cognitive neuroscience. It is focused on modeling two kinds of representation: declarative and procedural.

AIXI uses Reinforcement Learning (RL) to “maximize rewards”. It is relatively theoretical and has not been extensively applied.

CHREST models long and short term memory, perception, and reasoning, with memory based on “chunks” which are interconnected symbolic representations. It's been primarily applied in Chess, not broader AGI.

CLARION explicitly models “drives” such as hunger and fairness, memory in both symbolic and connectionist modes, and actions it can take. Clarion has been applied to various specific domains.

LIDA from the University of Memphis, a hybrid architecture based on two hypotheses: 1) Much of human cognition functions by means of frequently iterated (˜10 Hz) interactions, called cognitive cycles, between conscious contents, the various memory systems and action selection. 2) These cognitive cycles, serve as the “atoms” of cognition of which higher-level cognitive processes are composed. LIDA articles explicitly mention and attempt to model “consciousness.”

IBM's Watson, although focused on question-answering not complete AGI, has what might be called a cognitive architecture:

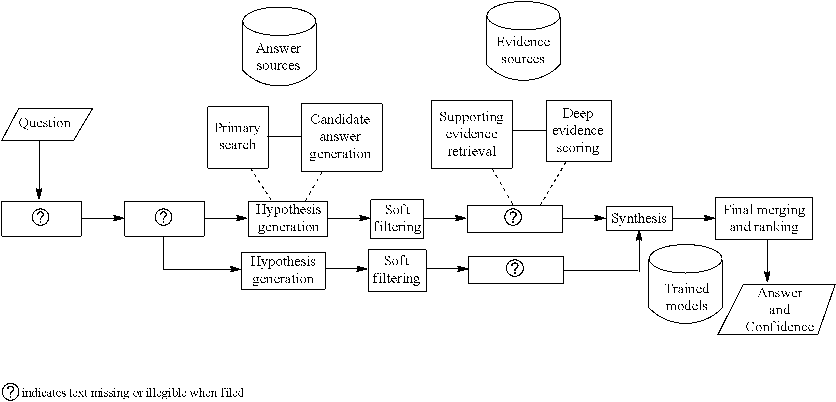

One must presume that with the advent of ChatGPT, many AGI researchers are currently experimenting with including LLMs within their cognitive architectures. There are at least as many ways of doing so as there are such architecture models. These may well emerge in publications within the next year.

Our review of cognitive architectures uncovered none closely modeling human conscious processing per our proposed model. CLARION and LIDA have some similarities, but their particular architectures are very different from ours. See below figure by Graeme Smith (adapted from Official Clarion Website Presentation, CC BY-SA 3.0, https://commons.wikimedia.org/w/index.php?curid=6225475):

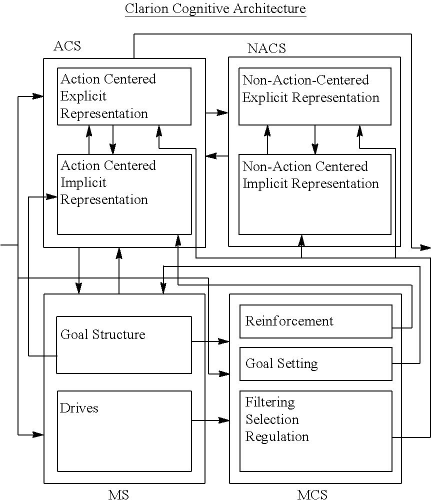

One article by Reuben Cohen promotes a new architecture which is similar to ours, at least at the high level included in the article: https://www.linkedin.com/pulse/building-sentient-ai-systems-navigating-balance-between-reuven-cohen-ehlqc/. Cohen's approach includes LLMs, a model for consciousness (GNW, also referenced in ours), with action and memory and learning processes. The article does not go into enough detail to identify differences from ours and does not appear to have been patented.

### Similar Patent Applications

Here is a brief summary of the 11 existing patent applications found which bear enough similarity to our proposal, based on the searches described above, to require distinguishing how ours is unique. None of these have been granted, as of August 2024.

US 2021/0034959 A1, “Continuously learning and optimizing artificial intelligence (AI) adaptive neural network (ANN) computer modeling methods and systems”. Mix of high level architecture diagrams with details about neural nets as components, missing how to actually build it.

US 2014/0046891 A1, “Sapient or Sentient Artificial Intelligence”. Proposed earlier than LLMs became well known, this architecture suggests Expert Systems technology as the central processor, unlike our use of LLMs for subconscious processing.

US 2008/0243750 A1, “Human Artificial Intelligence Software Application for Machine & Computer Based Program Function”. Proposes simulating human intelligence, but is primarily focused on search technology, a particular type of algorithm.

US 2008/0256008 A1, “Human Artificial Intelligence Machine”. This is essentially the same patent by the same inventor as #3 above.

US 2009/0164397 A1, “Human Level Artificial Intelligence Machine”. Yet another near-copy of #3 and #4 above, by the same inventor, this time adding a “Time Machine”.

US 2017/0372191 A1, “System, Structure, and Method for a Conscious, Human-like Artificial Intelligence System in a non-natural Entity”. The description of how to build this is incomplete, but it does focus on a set of human “values” to use in making decisions.

US 2018/0211180 A1, “Theory of Nonbiological Consciousness”. This brief patent application mentions consciousness and qualia, and includes several AI chat bot conversations, but does not describe the structure of how an AI might be built.

US 2018/0330048 A1, “Genome and Self-evolution of AI”. While having the same goal of AGI, this paper proposes setting up a base system that evolves to become intelligent, where our proposal includes the full architecture for AGI.

US 2019/0258254 A1, “System and Method for Conscious Machines”. Like ours, this proposal aims at replicating consciousness, including neural nets as the basis of reasoning, but focuses on the idea of building a virtual model of the world within the AI, although it does not offer a description of how that is to be modeled, and does not have the value-based reasoning we propose.

US 2019/0354102 A1, “Autonomous Robotic System”. While the application mentions the goal of achieving consciousness in a machine, its descriptions and diagrams are about the hardware, and do not address the information or reasoning architecture as ours does.

US 2021/0034959 A1, “Continuously learning and optimizing Artificial Intelligence (AI) Adaptive Neural Network (ANN) Computer Modeling Methods and Systems”. This proposal includes a reasoning architecture aimed at simulating human reasoning, including emotions. The architecture is different from ours, as can be seen in the very different system diagrams. The language of the patent application is dense and obfuscated, but it appears to be missing descriptions of how to actually build the system.

### BRIEF DESCRIPTION OF DRAWINGS

FIG. 1 summarizes the architecture, and is explained in detail in the Detailed Description section below, including instructions on actually building out the system. The figure shows the main subsystems of the architecture. Several of these subsystems are fulfilled by Large Language Models (LLMs), that is the current leading technology for Artificial Intelligence (AI). What makes our invention unique is the layer of technology above and using LLMs, with a defined process for addressing the known weaknesses of LLMs, applying recent research from the fields of Cognitive Science and Neuroscience.

### DETAILED DESCRIPTION OF THE INVENTION

The proposed architecture is for an ongoing computational process, with a handful of parallel threads, each thread consisting of a sequence of qualia.

Qualia (originally from philosopher Charles Peirce in 1866) are individual, atomic thoughts, emotions, or perceptions. One “quale” might be the hearing of a single note of music, or seeing the button on your friend's blouse, or an unspoken sentence, or a decision to act.

Are these threads continuous or discrete?We hold that qualia are atomic, or discrete, just as the feeling we have of continuity in music or across a visual image is an illusion created by the subconscious processes of our neurons. One reason is that brains appear to work as atomic firings of synapses, organized to mean something, not as some gradations along an infinite scale.

Threads begin and end, sometimes within a split second, sometimes lasting many minutes. People with highly developed focus might sustain a single thread for an hour. As we listen to a piece of music, one thread is the sequence of sounds as we hear them. If we listen intently, we might actually have that thread in our conscious mind throughout the entire piece of music. If we get distracted, and turn our attention to some other emotion or sight or sequence of thoughts, our consciousness might lose the thread of the music. Our ears and lower nerves are still processing the sound, but we are momentarily unaware of it. We can consciously be aware of only so many threads at once, so sometimes we do not hear, or see, or feel, while our consciousness is busy with something else. Thus, for example, going into shock will remove pain from our consciousness for a time.

Threads do not end so much as they go quiescent, garnering insufficient weight to beat competing threads for attention in the crucible of consciousness. So the thread of sounds we're listening to can fade out of attention due to intense concentration on a train of logical thoughts or a book we're reading or a stunning sight.

We juggle several conscious threads at a time, which is equivalent to an interleaved sequence of qualia from different threads. Within any given second, we are typically aware in parallel of something we're seeing, something we're hearing, and some series of thoughts or emotions. We would all be amazed, but find it conceivable that some “genius” could think of 10 or 20 things at once, but if they are human, not more than that. Most people are “maxed out” with a chaotic sequence of 2 to 4 thoughts per second, often in 1 to 3 streams, in parallel with flitting perception of one or two of their senses, that is a total of 2 to 5 conscious threads at a time. Several researchers have suggested the human brain works normally at a 10 hz clock cycle (e.g. https://pubmed.ncbi.nlm.nih.gov/27547831/). Perhaps some people are limited to a single thread at any one time, so they cannot think at the same time as listening, or hear anything consciously while they look. Probably some people readily juggle seven. We could build an AI with any number we have the chips for, but suggest starting with 3, to better study and validate the operation in comparison with humans.

What determines the threads that enter consciousness, and which ones leave? This is a combination of conscious and subconscious thought processes. We can will ourselves to listen, or watch, or to create a particular series of thoughts, but subconscious processes often intervene and force other threads into awareness. A loud noise or surprising sight will drive that sense into our conscious stream. Urges or habitual thoughts will drive themselves in. Some people, including for example experts in meditation, can exert more conscious control, deciding what threads are included, but rarely or perhaps never is that control absolute. For survival, the human brain has been conditioned through evolution to bring various threads into awareness as needed.

Indeed, a large fraction of our subconscious thinking is a set of neural nets, some of them equivalent to LLMs, busily deciding what to surface into our consciousness. Their inputs (prompts) are the streams of inputs from the lower brain levels processing our senses, as well as our short term memories, which include some of the recent not-quite-conscious thoughts: candidates which did not enter consciousness, but were proposed by threads. Their weights would be adjusted in response to the resulting pain and pleasure, as measured by other nets, according to Jeong et al's ANCCR model. The nets are initially wired and weighted from birth by our DNA, for example to bring sudden loud noises into consciousness, or sudden movements into our visual field.

Many threads may function much like the output of ChatGPT. Based on its training, ChatGPT uses an input query, called a prompt, plus all the words it has replied with so far, to decide the next word to output. ChatGPT's reply, assembled word by word, seems a lot like a thread of consciousness, a new word popping into thought based on the previous words.

We distinguish five kinds of thread.

First, there are streams coming from our senses, with a different nature for each type of sensory organ. From the eyes and ocular processing nerves, there are “movies” of visual imagery. The eyes are continually working, as is the optic nerve, and higher levels of nerves, without any consciousness, generating movie clips. Frequently, indeed almost continuously for most humans, those movie clips are indeed one of our conscious threads. To clarify, these are not video files as stored in computers or on film today. They are the interpreted narrative that people are able to “see” in their consciousness. One might see two bear cubs climbing a tree, with mother bear looking on, have a vague notion of mountains in the background, a rocky scree between me and the mother, and a surrounding forest, but not see any other details. One might have a vague impression of the blackness of the mother bear and her cubs. What kind of tree?What color rocks?These may not enter consciousness, even while seeing them live. The video our senses perceive gets distilled to what we can describe in words, and it's unlikely we'll remember much beyond what we can say.

From the ears, there is an ongoing sound track, to which our consciousness frequently pays attention. Sometimes we are not conscious of sound, our consciousness focusing on sights or thoughts or something else, but much of the time, the sound track is one of the conscious threads. Other senses pop into consciousness less frequently, and for most humans, with less complex qualia than vision and hearing.

Second, there is an interesting type of thread we might call “reconstructed sensation.” This includes memories of what has been seen or heard or felt. It also includes imagined sights or sounds or feelings. You remember a lover's face, or if you're Mozart, an entire symphony plays in your mind before you've written a note.

Third, there is the sequence of “thoughts.” For most people, this is a series of words, an inner conversation. It is not a clean, logical flow of creative ideas, but neither is it a completely random sequence. It is a messy construct part way between a never-ending narrative and an impressionist poem. It stutters and restarts. Occasionally a coherent grammatically correct sentence emerges.

Fourth, there are emotions. Anger or fear or joy or love suddenly appears in our consciousness. For a moment, or a series of moments, we feel that emotion, we are aware of it, and perhaps it changes over time as a sequence of feelings. Usually there will be a parallel stream of thoughts about a certain person or situation putatively causing that emotion. Or we might be conscious of a surge of joy while listening to Beethoven's Ninth.

Fifth and finally, there are “commands.” We tell our muscles to move a certain way, or we tell our thoughts to work down a certain path. An interesting sub-type is the command to remember something. It does not work very well in most humans. We might force something into our short term memory, but it usually takes multiple repetitions of that command before some subconscious system transfers it to long term memory. Perhaps we should strongly divide mental from physical commands, the former focused on our brain activity, the latter involving the body's muscles. Note we are not claiming all commands are conscious. The human brain issues many subconscious commands as well, continuously regulating the body, or implementing the detailed steps underneath a conscious command, such as triggering a dozen muscle groups we are not aware of, to achieve “type the word TYPE” which was consciously thought. Note also a difference between thinking about doing something versus doing it. The former is a thought, a set of words, or a visualization of an action. The latter is what we mean by this thread: if a command enters our conscious stream, this means that command is communicated out to our muscles, which implement it.

We have conscious commands to contract muscles, to remember something, and to think the next conscious thought. Some people claim the ability to control some other aspect of their body, other than their muscles and conscious thoughts. For example, some people may be able to direct their unconscious thinking to some level. Some may be able to control energy flows within the body, other than through the understood mechanism of nerve signals causing muscular contractions. This is the claim of many advanced martial artists and yogis. These are interesting areas for research, but set them aside for now, and posit that all our poetry, music, running, grasping, breathing, painting, crying, and dancing can be done through sending signals from our brain to our muscles.

### Macros

There is an interesting variant of commands, which we call “macros.” Similar terms we could use include function, subroutine, composable module, microservice, or object method. In many software systems, macros are sequences of commands, summarized by a one-word title. Once a computer is taught a certain sequence of commands, one can run that macro without having to remember all the individual steps. Similarly, we train our mind and body on certain sequences, and just remember the name of the macro. Babies learn macros at incredible speed. Even as adults we can still learn new ones.

Similarly to the macros bundling a sequence of commands, we use labels and other groupings to organize our sensory qualia. A picture that emerges in our consciousness, for example, can be examined in parts. An audio clip can be divided into its notes, or other sub-structures. We can zoom in or out, and have the item in our consciousness at any level of granularity. One might see a woman's face in the mind's eye, then the next split second shift consciousness to her left eye, then switch to the emotional attachment one has to her identity.

Macros we would pre-build into an AI include “display this on the screen,” or “Tweet this,” or “Open my social media account to read the latest feed.”

### Logic and Creativity

Let us return to the third type of conscious thread listed above: “thoughts.” For many people, these are mostly messy, ungrammatical, lacking in logic or even coherent narrative. They jump around chaotically. However, they do occasionally coalesce into grammatical phrases. When they do, they sometimes even perform feats of creativity or logic. How does that come about?How much logical reasoning do we have at our disposal in our conscious thinking, or our subconscious thinking for that matter?

This model presumes we have some logical rules built into our subconscious. We add to them over time, reinforcing those that serve us. Perhaps we are not born with many or any formal rules of logic, but as adults we certainly have some, and lots of evidence points to us coming prewired with an extensive instinct for language, as well as moral judgment (see Pinker's The Language Instinct, and Haidt's The Righteous Mind). We know that if all people have brains, and Tommy is a person, that Tommy has a brain. That thought pops into our consciousness as being logical and true. We build many such rules, such as what the next integer in a sequence is. 452, 453, 454, 455, then what? You've probably never seen that particular sequence before, but the next number readily pops into your consciousness. Math students like all humans work hard to internalize more sophisticated rules. We weight conditional probabilities, we work out complex logical sequences. Sometimes we need to put complex sequences on paper, or go over them in our short term memory over and over, to tease out the right rules to apply at each stage, as everyone who has tried to prove a logical theorem as part of a college assignment can attest. What happens in consciousness is that the next thought arises as a logical conclusion of the previous thoughts. Sometimes it is a simple memory retrieval, but sometimes it is the application of a logical rule, one that we have trained our neural nets to apply.

When we have an “aha!” moment, this can be modeled as three things happening at once, or in such rapid sequence that they feel practically simultaneous. First is the conclusion appearing in our consciousness. Second is the emotional affect coloring the conclusion, due to realization that it's a significant one, a judgment that this thought is extremely wonderful, true, or good. Third, optionally, is awareness of the final rule, the logical step which led to the “aha”. It's not enough to see the beautiful truth; we appreciate it most when we see how we arrived at that truth. This lets us automatically give that rule greater weight in future situations. This aligns with the ANCCR model mentioned earlier, for continual retraining of our nets.

Triggering off the senses may be the simplest, although not simple. It is well established that our senses work in layers. For example, the neurons at our retina pick up spatially located points of color, leading to other neurons which build up edges and other geometry, ending up with parts of the brain “seeing” people and objects and clouds and all the rest of our visual world. We have some triggers at lower levels of that hierarchy, so that our consciousness is alerted (for example) when there is sudden movement somewhere in our view. We also trigger off recognized objects. We might stay blithely unconscious of our visual field while we think of other things, then become aware suddenly of a word we've just typed. One way to understand this focus of consciousness on bits of our visual sense is to think about what we are not conscious of. As I type this sentence, I think back and realize there are people within my peripheral vision that I'm aware of now, but was completely unaware of as I typed the previous sentence. They were there. My eyes subconsciously saw them, but they did not enter my consciousness. If one had shouted suddenly, they might have.

Perhaps we used the word “triggered” too loosely. Our neural net technology today is based on quantitative inputs, a set of input numbers at each iteration of learning or doing, tied to the input nodes. What would the “values” be for a net whose inputs are the visual system?Some would be hard-coded by our DNA, such as the visual system detecting sudden new movement anywhere, or any significant sudden change in what we see. That would be a yes/no signal, or perhaps a measure of how significant, such that if it's high enough, it would win against other candidates to become conscious. For higher level sights, such as a lover's face, that visual recognition could spark a high significance score, linked to the sight. If the score is high enough to override other candidates, the net would choose that visual link to push into consciousness. This suggests that the visual system has a buffer where its current unconscious recognitions are constantly refreshed and scored. Imagine an array of a hundred or a thousand slots where the current visual field is laid out as a set of things one sees, each with a significance score.

Note a major difference from how most LLMs are prompted today. An LLM is normally provided a single finite sequence of words as a prompt. It then generates its first word of response, and uses the initial prompt plus that word, as prompt for the next cycle, to generate a second word, and so on. What we suggest is that the prompt for a given cycle consist of the recent set of conscious thoughts, that is our short term memory, including new sensory impressions, and other streams. This would be like allowing a user to interrupt ChatGPT with additional prompting midway through its response, and having that interruption become part of the prompt. While it may be difficult to add a sound or emotion or image as part of a prompt for an LLM, it should not be difficult to add the words we use to describe that sound or emotion or image. Imagine ChatGPT is generating a paragraph in response to a question, and half-way through, the word “yuck” is inserted into the prompt. This would change the rest of the response, particularly if inserted repeatedly, by a separately trained judgment or emotion module.

The role of emotion in this algorithm is interesting. Frequently the highest scoring thought, and hence a conscious quale, is the arising of an emotion. If strong, this emotion scores highly on our judgment, and invokes changes to weights, steering us and training our subconscious toward different paths—reinforcing recent decisions for positive emotions, and descaling them for negative.

Is our subconscious trained to seek truth, or pleasure, or some other abstract set of values? Are we largely trained by our DNA such that consciousness is whatever helps us survive? To the extent that we retrain those nets, do we focus on truth, or do we even have a say in what we focus it on? For the net we are born with, the answer is “all of the above.” Evolution has created our subconscious to help us survive. That means nets trained for a combination of truth-seeking, values affirmation, pain avoidance, and pleasure-seeking. As we grow up, we refine those innate values, changing them into all manner of abstract ideals.

A consolidation of all these values is necessary for an effective mind. We can call it “the pursuit of beauty,” with a specific definition of beauty: a weighted sum of truth and goodness. By truth we mean reproducible predictability, or “scientific truth.” By goodness we mean the sum of our five innate moral measurements (per Haidt's “The Righteous Mind”), as modified over time to produce our unique ethical fingerprints. AI developers have already run into the challenge of building “good” AI, with training mistakes leading to AI generating racist, untrue, misogynist, or other evil statements. Creating good AI in the moral sense requires good training. The architecture proposed here offers an improved platform for training sound ethical judgment into our AI—allowing the LLM to act as a creative subconscious, while separately training a set of ethical value nets to police what is actually said or otherwise acted upon, similar to the judgments humans make of the various ideas that pop into our heads. Training those judgment nets becomes analogous to raising healthy children, albeit children who can voraciously consume input and feedback at superhuman speeds.

### Training and Retraining the Subconscious Nets

Jonathan Haidt argues in The Righteous Mind (2012) that humans are born with certain basic moral programming, which adapts and is refined through our childhood to trigger differently, as our culture reinforces various rules. Evolution gave us some built-in programs, five standard ethical dimensions:
Care for others (do not harm).
Seek fairness and shun cheaters.
Be loyal to your group.
Respect authority figures.
Seek purity, that is, avoid poison.

In one culture, seeking purity becomes seeking godliness, or loyalty becomes patriotic willingness to die for one's country. Strong emotions come from leveraging those basic programmings.

The model will evaluate on these five separate scales, plus one for pleasure vs pain, and one for truthfulness or accuracy. The subconscious amalgamates a score for every sensation, every memory, every thought, which is used to change our conscious mind in several ways. First, strong positive or negative scores will surface such qualia into consciousness. Second, we assess a thought that's become conscious, and slightly refine the scoring nets in response: reinforcing the weights which lead to high-scoring thoughts, whether positive or negative. In other words, if we really like a thought we just had, we're more likely to think similar thoughts again, and if a terrible sensation of pain hits our consciousness, we're going to reduce the weights of recent thoughts, which presumably led to that pain.

For example, if we tell ourselves to meditate, and this leads to a state of mental bliss, which we evaluate as very positive, the weights will shift to reinforce the meditation macros, and make meditation pop up as something to do more often.

We know from Zajonc's paper in American Psychologist (1980), “Feeling and Thinking: Preferences Need No Inferences”, that our brains score incoming ideas faster than we consciously evaluate them. We don't think about something, and then decide consciously whether it's bad or good. Rather, we almost instantly assess it as good or bad, and then rationalize the assessment. Only with extensive repetition can we change our programming, and consciously decide to change our moral algorithms. More often, we employ our rational thinking to defend our instant moral decisions.

This leads to the following suggestion for initial training of an AI. There are two sets of nets to train. First is the “next thought” net, which selects for each stream what the next conscious thought should be. Train this one as we have trained most nets for decades now, including the LLMs: on as much data as possible, to present consciousness with accurate thoughts about the world, with importance ratings similar to what humans have long felt was important. This likely means digesting the Internet, at the risk of producing lots of false data. That's tolerable; humans have managed rocket science despite false memories, and a subconscious that surfaces all manner of crazy ideas. In fact, we can simply use the LLMs, voice recognition, and image recognition nets already available on the market.

This first set of nets need different training for the different types of stream: one for each sense, one for emotions, one for thoughts, one for commands. Current LLM training is already quite close to the “stream of thoughts”. Training emotions may be closely tied to training the 5-axis judgment nets. Several of our emotions align with those values.

The second set of nets to train is the judgment module. This yields a score for each candidate conscious thought. Training the judgment net is harder. It has to reflect some version of pain, pleasure, truth and morality. For the morality component, we can use assessments based on Haidt's moral dimensions, as well as Asimov's laws of robotics.

How do we train a net whose purpose is to suggest commands? For a human being, with 288 groups of skeletal muscles to control, with uncounted numbers of coordinated macros, training is very complex. For a first conscious AI, we can propose a simpler regimen, but perhaps a bit more exotic than ChatGPT's. We will start with a handful of command macros, which our AI should be able to generate as its next conscious thought. One is to display a set of text. This is essentially what ChatGPT does in response to a prompt . . . but ChatGPT does this with simple certainty: you give it a prompt, and as soon as the next word in its sequence of response-building is a “stop” sign, it displays the sequence. It never holds its tongue, except in the sense of having been trained to say certain things and avoid others. It never speaks without being spoken to. It responds to prompts in its command window, and nothing else. Our AI could decide at any moment to say something, or to stay silent.

### Memory

How would the net decide on a memory being resurfaced? It can use the pleasure and pain measurement mentioned earlier. We are constantly evaluating the pain and pleasure score of each of our thoughts, memories, and sensations. If a memory has a very high score on either, it's likely to surface.

How does memory have to be structured for this to work?Why would a certain memory suddenly “pop” out? It seems unlikely that our entire memory would be evaluated at every iteration. It seems more likely that some relational association “fetches” it. We hold a number of thoughts in our short term memory, each of which has many links, and each of those associative links is scored, that is weighted, and the highest weight wins, bringing that association forward. That doesn't seem to explain odd old memories coming out of nowhere, though. There is a process, trolling through old memories all the time, considering which to surface.

That is our proposed fundamental consciousness machine operation, the “clock cycle” of our consciousness. This type of operation is equivalent to the recursive functions of a programming language, that is Turing equivalence. In other words, this cycle is all that is needed for conscious thought to achieve everything any computer can do, in a logical sense.

The possibility is that a “memory” popping into consciousness is really just a constructed thought generated by a neural network trained on your whole life, something like the stream of words that ChatGPT puts out in response to a query. We tentatively reject this approach for a few reasons. First, although memory is plastic and unreliable, it doesn't appear to be entirely fabricated. It simply seems on introspection defensible to claim our brain includes a long term storage function, where a collection of thoughts and impressions are, albeit imperfectly, placed and retrieved and modified. We prefer to pursue an approach where the subconscious neural networks work with a memory storage system, which we characterize below.

We know our memory is starkly divided between a quite limited amount of short term memory, and a vast long term memory. It is worth thinking of short term memory as a fixed number of cells whose contents are replaced every few seconds with the most salient conscious qualia, or rather including candidate qualia from various threads, even if they didn't quite surpass the consciousness threshold. I just saw a bright orange Fiat across the street; I've turned my eyes down to this iPad screen, but the Fiat's still in my short term memory. Because I'm thinking about that, it stays there longer than it otherwise would, and even comes back into my consciousness periodically while I write this sentence. Other things I saw at the same time have slipped away, not stored in long term memory, never to be retrieved again. Perhaps there are a few different kinds of short term cells, a few for each type of quale.

The top few candidate thoughts of each cycle are placed in short term memory. So, for example, I may not quite hear what you said just now, as I was thinking of something else, but then I can retrieve what you said, and parse it a few seconds later. These short term memories are either reinforced by what happens next in consciousness, or they fade to irrelevance if never accessed. The mechanism that constantly retrains our nets on what to bring forward includes weighting the value of memories. Strong weightings mean that memory becomes a long term memory.

Note a difference between the scoring that brings a quale into consciousness, versus the scoring of the current conscious quale to change weights. Out of parsimony, we expect they share calculations, but the former is an absolute value, while the latter is positive or negative. So a very negative painful sensation will burst into consciousness as the highest scoring item, but then be scored negatively, to reduce weights of recently “successful” pushes. Does this seem circular? If the highest weight puts a pleasurable thought into consciousness, which then scores positively, and further increases the weight for that thought, causing it to come into consciousness again, won't that escalate so nothing but that thought is ever thought again?Indeed this almost happens when people successfully meditate, as the bliss of meditation supplants all other thought, for a time. Why does it not escalate forever?One reason is that reality intrudes: our chemical bodies continue to change in their physical environment, so sensations like hunger or fatigue impinge, or something bright or loud interrupts us, with a high enough score to override other thoughts. Also, we expect there is a “peak weight” for thoughts, to prevent them overriding genetic predispositions that protect us from danger—we can't be thinking about pretty flowers too much if a lion is hunting nearby.

Also, the scoring of one quale may adjust the weights of several recent pushes, not just the one that led to that particular quale coming in. For example, if I command my finger to touch a hot stove, and a second later the genetic weights on sensation bring a horribly painful surge to my consciousness, the negative evaluation of that sensation will go back and reduce the weights of the net that brought that command to consciousness—and presumably not muck with the genetic weight that prioritizes pain. (Although, perhaps what we call “shock” is some form of temporary change to these.)

### Goals

In this model, what does it mean to have goals?

Jonathan Haidt published the idea that consciousness evolved as a guide for the subconscious mind, not its master. His metaphor is of consciousness as the rider on the elephant of the subconscious. The rider can influence and guide, but the elephant has its own mind. We may have conscious goals, but our elephant has its preconfigured, subconscious goals as well. The same applies in our proposed AI, to resolve many of the problems ascribed to LLMs.

Recall Jonathan Haidt's claim that humans are preprogrammed with five ethical values, which are instantiated and tweaked by our environment, but nevertheless foundational to how we judge and view everything. We can consider these, along with instinctive drives like hunger and sex, as our fundamental goals as humans. We refine them through our lives, interpreting them in light of our growing vocabulary and experience. Here they are again, with some commentary:

Harm—it's bad to harm somebody, including yourself. Thoughts or actions that result in harm to anyone get a “bad” score in our head. The higher the harm, the more severe the score. Knowing what will happen if you touch a red hot stove, you are inclined not to touch it. With appropriate weights, this constitutes Asimov's first and third laws of robotics.

Fairness—the golden rule. Fair exchanges score well, theft and cheating score badly.

Loyalty—doing things that support “the team” score well. This is the foundation of “family comes first”, nationalism, patriotism, racism, party loyalty, and fandom. Betrayal scores poorly.

Respect—do what authority figures say. Breaking legitimate rules is bad. Again with appropriate interpretation and training, this is Asimov's second law of robotics.

Purity—clean is good, dirty is bad. This stems originally from the evolutionary need to avoid poisons and disease. We are revolted by feces, foul odors, and other dangers. We generalize this ethic as we are indoctrinated into a religion, to view anything proscribed by the religion as unclean. Thus we're revolted by evil, as defined by our upbringing.

With these value systems in place, we can program Asimov's Three Laws of Robotics into the AI. In this framework, they can be seen as a tailored version of the Harm and Respect goals, with particular weight given to respect for humans.

We can train LLMs to act as the subconscious of an AI. To give our AI a sufficiently moral and effective consciousness, we include training in the 5 moral dimensions. This means effectively “raising” the AI well, training it to score its inputs on Harm, Fairness, Loyalty, Respect, and Purity axes. The judgment net scoring to determine our next thought, and to evaluate a thought once conscious, is the sum of its 5 moral scores, plus scores for truth and pleasure.

### A Conscious Programming Language

We can elucidate a programming language in which conscious thought is programmed, a language that has evolved, in conjunction with the rest of the mind, to improve overall survival of the species. Let's call it the Consciousness Programming Language, CPL for short.

Memory appears to have far more structure than a flat set of qualia. We have a model of the universe in there. How is it structured?How can a whole structure of thoughts be represented?How does it affect consciousness? Are complex structures a separate thing from consciousness?

The CPL at minimum needs to support the computational complexity of our abilities in predicate logic. By this we mean not just something like Turing completeness, although we include that, but also an ability to reason with the efficiency we actually observe in humans. It will map closely to the deep structure of language, as mentioned earlier in reference to Pinker's book. Looking at a typical exhaustive list of programming language elements, we explain to what extent they are included in the CPL. Our guiding principle is Occam's Razor: deciding the least complex possible language that supports the performance we actually witness.

Data Types: we do not have real numbers. We have just “labels”, a handful of small integers, true/false, and something like a “statement address”. The latter is like a go-to label in FORTRAN, a way to get to a particular place in the program. One possibility is the notion of “schemas” once popular in AI, originally proposed by neurologist Henry Head in 1920. Analogous to objects in object oriented programming, a schema is an object with a set of attributes, each attribute being a key-value pair, that is a name and a value. But if our fundamental data structures are such objects, do they have fixed sets of attributes?(Probably not.) Unlimited numbers of attributes?(Probably not.) Can we give each attribute a new label?(Maybe.) What can the values be?(Probably just other schemas.) Maybe each schema has one fixed attribute which is its “name”, since we love to name things. What are labels?(Perhaps just schemas, again, out of parsimony.)

Variables: we do not have arrays. We have a limited number of typed variables, perhaps analogous to our short term memory. We don't have variables named A, B, C like simple computer languages. We do have pronouns like “she” and “it” which temporarily hold values.

Logical and Arithmetical Operators: Not many. Most of the math we can do is multi-step symbol processing. We don't have a “+” operator, for example. We have learned the symbol manipulation to conclude 2+2=4. We might at most have an innate preprogramming to recognize that nothing plus one is one, and build from there.

Loops: No. Most modern programming languages have sophisticated looping mechanisms, but human consciousness is not modern. Instead we have a very sophisticated form of pattern-matching “go to”. Fundamentally, programming in a Turing Machine sense can all be done with if-then-else and go-to statements.

If then else: Yes. The interesting part is what kind of truth conditions we can test, and what the structure of the action is.

Functions: This gets interesting. One formulation is “variable=f(x)”, in other words, set that variable to the value of function “f” applied to “x”. How can functions be constructed? This might be an associational lookup, like everything else on the boundary between conscious and unconscious thought. “x” is the object. The function F is its attribute, and the value of the function is the value of that attribute. Either it's a direct retrieval for functions and values we've memorized, or it's a reference to another object which helps us calculate F for x.

Input and Output: Earlier we described the two possible “commands” that consciousness can execute, namely attempts to influence memory and subsequent thoughts, and commands to move volitional muscles. These are the full complement of “output” statements in the CPL. Input is more complex, as we do not consciously control our inputs other than to move our eyes' focus. We can tell ourselves “read this page” and our muscles will move our heads and eyes to look at the page, but whether the words on the page actually then enter our consciousness is up to the subconscious ranking mechanisms we describe elsewhere. Something else might come up that's higher priority, such as a loud sound, or a thought unrelated to the page of words. In other words, the CPL actually has no input statements. This is not to say that the running conscious program has no inputs, just that they are not directly controlled by statements in the language.

This language will be recognizable to computer scientists as a close variant of the original Turing machine. This is not a coincidence. Turing was looking for a simplified model of how the human mind does computation. A mechanistic algorithm (our subconscious) looks at a label, and moves to the next label, after making a small adjustment to the current label. While Turing aimed for a minimalist model, we are aiming for one that is isomorphic to what we now know about consciousness.

### Human Language Vs the CPL

Steven Pinker demonstrated in The Language Instinct (1994) that humans come prebuilt with a form of language. The original concepts came from Noam Chomsky's seminal work on linguistics in the 1950s, and have been proven through decades of painstaking science. This “natural deep language” and the CPL are almost one and the same. Imagine the brain as a computer system, where consciousness is a core part of the operating system, with the CPL as its programming language, and the human language instinct as the initial programming.

We come built in with a number of CPL schemata: sentences, noun phrases, verb phrases, and a vocabulary of some essential nouns (mama!), verbs (eat), and adjectives (hungry, loud, bright). These essential words are missing their pronunciation and spelling, but they exist already in the brain, waiting to be taught how to hear and say them.

Pinker noted evidence that humans parse and understand language “depth first”, that is assuming the most likely tree structure of a sentence as it comes in, backtracking if a word comes in that violates the current tree. This aligns with the idea that we process one thought at a time, using recent memory to decide our next thought.

### Applicability of LLMs as Subconscious Models

The emergent properties of LLMs have arisen just as they grow to the approximate size of the human brain. LLMs of smaller size were ridiculed as stupid, but with ChatGPT trained using billions of nodes and billions of inputs, it performs as well as humans, or better, on many tasks. As suggested in the Apr. 20, 2023 special issue of The Economist, we may now discuss the training of LLMs similarly to how we discuss how well a child was raised, noting biases and faulty reasoning. We may have to psychoanalyze our LLMs to poke into the origins of their pathologies. All this reinforces for me that LLMs are excellent models for human subconscious thinking, and not for conscious thought.

ChatGPT considers its prompt, and applies its training to suggest the first word of its response. Then it takes its entire prompt plus that first word, to suggest the second word of its response. It continues until its top suggestion is to stop. Our proposal is to use an LLM as the subconscious, putting that first word or sentence (thought) into consciousness, but from that point, using the “conscious process” outlined in this paper for the next step. We expect different behavior than ChatGPT's. The conscious thinking may result in a command to speak or type a sentence, but it may also choose to be silent. It may raise candidate responses, and then apply judgments to them, flagging them as dangerous or silly or wrong. It will remember such judgments, and be able to summon them if asked why something was said or not said. This may overcome some criticisms of LLMs as black boxes, although the computer will have the same limitations as humans in being able to explain its subconscious thought.

### Architectural Layers

The computing cloud of the 2020s requires at least a dozen layers of architecture to explain and understand it. There is the physics of semiconductor transistors, chip architecture, boards, operating systems, programming languages, software and database and multilayered communication designs, and business process models, to pick a few. Yet the preponderance of brain research attempts to jump directly from neural synapse firing patterns to mental algorithms. We will make more progress once we divine more layers of mental architecture.

For this reason, we have devised a model at the top level of architecture for mental reasoning, working downward far enough to realize it in software. This leaves to other researchers the hard work of figuring out whether or how the human brain hardware supports this software architecture.

David Chalmers bet in 1998 that even in 25 years, there would be no firm evidence of “neural correlates of consciousness”. He won some bottles of wine in 2023 as a set of experiments were inconclusive about two different possible architectures for consciousness. Whether there are “consciousness neurons” or not, we are more interested in the structures and algorithms of consciousness at a higher level. If aliens came to study human's computers, some would be interested in figuring out whether there were CPUs amongst all that hardware, but other aliens would be reading the Java code. The latter would learn more about human computing. The ones reading architecture documents would learn even more.

One might ask what good this theory does, what deeper purpose it solves. Even if understanding the human mind is an important goal, does a descriptive theory like this one actually increase understanding?What does it provide beyond an obvious superficial description of introspection? Even if it were useful, what kind of evidence would prove or disprove it as a theory of mind?

That last question may be the easiest. It's a great candidate for the Turing Test. An AGI based on this theory will fare better at convincing humans they have human-like minds than Als without this structure. If true, consider that to be evidence that human consciousness is indeed constructed this way: not conclusive evidence, but a step in that direction. Introspection alone might be enough evidence for some people, but more objective evidence is useful. If we ask an AI “what were you thinking just now” and it answered honestly that it was weighing a million possible inferences from my previous sentence, we would find that less human than something about the most salient recent sensations or thoughts that entered its “consciousness.”

As to the earlier questions, there is value in having an explanation for interesting phenomena, both at a descriptive and causative level, and consciousness is very interesting. Some consider it the unique mark of humanity, the definition of what makes us human, or alive. If we were not conscious, would we be “alive” in the sense of being a live human being? This theory does not go into causes, but superficially it is worth mentioning that such a structure might well evolve through natural selection, where the organizing principles of a conscious mind lead to better survival than unconscious neural processes.

Commercial AI has already proven useful without consciousness, but implementing a conscious architecture as outlined here will lead to significantly higher utility. Computers with consciousness will be better general-purpose problem solvers. Already, the Tree-of-Thoughts theory for using LLMs as one component in a search algorithm has proven more effective on several types of problem than LLMs alone.

LLMs emerging as this is written are able to generate language at approximately the speed that humans speak. Already some are able to generate much faster than humans. It is worth noting that these LLMs appear to have similar numbers of nodes and connections as the human brain, with its 10 billion neurons. It is not a coincidence that the neural nets of the 1960s finally achieve human-like subconscious capabilities just as they finally reach the approximate size and complexity of the human brain hardware.

As for an Internet sense, this does not mean the initial training of an LLM on a subset of the Internet, but rather a live connection to the Internet, interleaved with an ability to enter text. The AI should be able to open a web browser, and type in search terms. It should be able to think of the action “let's post THIS on social media” then perform it, followed by perusing the same social media to read reactions. A simpler initial version might use a single window, a single tool, such as Facebook, to allow interaction in a controlled way with a significant part of the Internet.

Licensing a previously trained LLM similar to GPT3.5, the architecture proposed here is being built with a moderate software effort. A potentially large effort would be required to train the “judgment” nets, but an initial version is proving the principle with existing LLMs and prompt engineering.

### Building the AI

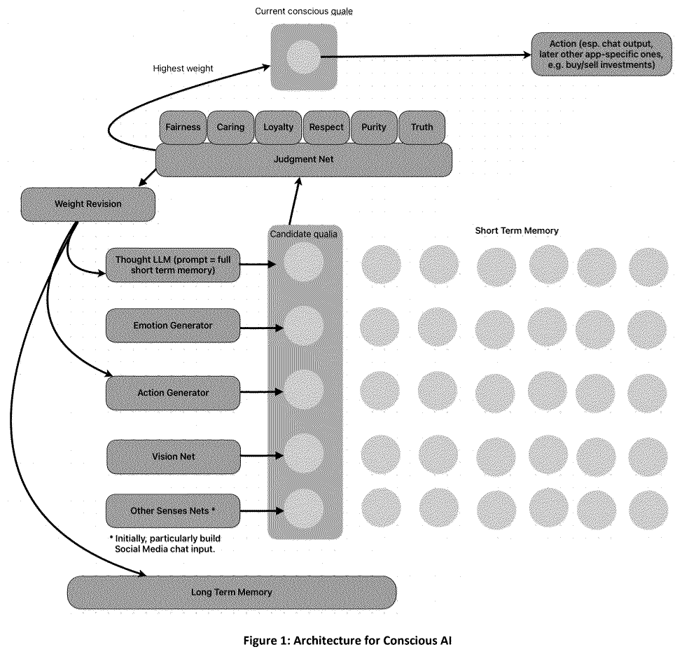

Begin with the short term memory, a structured array of “qualia”. A “quale” is a unit of thought. For version 1, a quale can be an English sentence. In future versions, qualia will be more sophisticated schema, which can represent a sentence as a deep grammar structure, and also other things such as visual representations of seen objects. Short term memory is a sequence of the seven most recent qualia generated by each “subconscious net”, the modules shown on the left of FIG. 1. So for example, the “Thought LLM” generates a sentence, which enters the first cell of short term memory. That sentence shifts right when the next sentence is generated by the Thought LLM, and so on.

The same holds for each subconscious net. In version 1, an important net would be a chat input. Each sentence typed into the chat would enter the short term memory.

The third and final subconscious net needed for version 1 is an action generator. This will in future versions support many complex actions, but for version 1 can simply generate the action idea “Output X” where X is one of the qualia recently generated by the Thought LLM.

The program has a clock cycle. For each cycle, the following things happen:

Step 1: Each of the subconscious nets generates a quale, which is placed in the left-most column of short term memory. That column is called the “candidate qualia”, as any of them might be selected to “enter consciousness”. For those nets requiring a prompt, the prompt is the entire short term memory, concatenated together.

Step 2: The set of “judgment nets” are applied to each candidate quale, generating a set of scores, that is a numeric score for each judgment net for each quale.

Step 3: A formula is applied to select one of the quale. This will normally be a simple sum of the judgment scores, but if any one of the scores is above a certain threshold, that will result in that quale winning preemptively. If multiple qualia have scores above the threshold, the one with the highest weighted sum wins, or an arbitrary selection among those that tie.

Step 4: The winning quale is placed in a special cell called the “current conscious quale”. This is analogous to “the next thought that pops into your head” for human minds. What enters your consciousness may be a thought, or something you see, or something you hear, or something you decide to do.

Step 5: If the winning quale is an action, that action is then taken. In version 1 the only options may be the simple output of a chat response. Future versions may include robotic controls, audible speech, commands to other programs, etc. One of the most important actions is to “remember” something, meaning to put it in long term memory.

Step 6: Whether an action or not, the scoring of the winning quale is used as feedback to the “trainable” subconscious nets, to either reinforce or modify their parameters, using the ANCCR algorithm described elsewhere in this paper. Depending on what nets are used, perhaps none will be trainable in version 1, but this can be bootstrapped with different, more programmable, nets incorporated later.

Step 7: The next clock cycle then begins, with the revised weights, and the updated set of short term memory as prompt.

Version 1 can use any of the commercially available LLMs as its Thought LLM, preferably one with an easy-to-use API, and relatively large prompt capacity. There needs to be an ability to obtain the first sentence (ie. quale) of a response rather than the typical multi-sentence responses LLMs normally produce.

Version 1's input and output can be a simple text window. For useful applications, later versions will support a social media chat, that is to manage dialogues in the IM tool of some social media platform.

The judgment nets need at least some initial training to function in version 1 to at least a rudimentary level. One low-cost approach is to use a commercially available LLM, with a standard system prompt inserted to direct the judgment. This is analogous to the hidden prompt additions some LLMs use today. For example, the Respect net could simply be a call to ChatGPT with prompt “Rate the following prompt from 1 to 10 on how well it represents a respect for authority: X”. Of course, more purposeful training of a custom net can get better results, and this will be a major area for ongoing improvement, but a simple method similar to this can establish version 1 very quickly.

The action generator for Version 1 would have just one action, to output the most recent sentence from the Thought LLM. The value nets need to default to making this action the next quale, after each sentence produced. That is, in Version 1, the clock cycle will alternate between a sentence coming from the Thought LLM, and an action to output that sentence.

Version 1 with trivial setup will behave almost exactly like the selected Thought LLM. Incremental improvements to the various components will improve the effective performance. In parallel with developing later versions, there would be a continuous ongoing training to improve the value nets.

The first thing to add in version 2 is long term memory. As with short term memory, long term memory can start with an English sentence as its basic unit. Items will be added to long term memory under two scenarios. One is if the current conscious quale has a weighted score above a certain threshold. Another is if the current conscious quale is an “action” to “remember X”.

Retrieval from long term memory also occurs through two different scenarios. Long term memory can be one of the subconscious nets feeding candidate qualia. Given the prompt of everything in short term memory, it proposes items from long term memory that match. A simple matching algorithm can be used to start, with more sophisticated ones swapped in later.

The second scenario for retrieving long term memory is when the current conscious quale is an action to “Recall things related to X” where X is another sentence. That can search long term memory for the best match to X.

Version 3 will add social media integration, that is adding an ability to read and write either the posting or messaging platform of some major platform (X, FaceBook, TikTok, etc).

Version 4 could be the addition of the emotion generator, which can start as a relatively simplistically trained LLM asked to generate one of a handful of emotion words or sentences: happy, sad, angry, etc. This can include “drives” such as “I want to help” or “I want to learn”. In a human, for example, the longer one went without food, the more likely this emotion generator will issue “I'm hungry!”

Versions 5 and onward will be built depending on monetization opportunities. Some of the candidate features are as follows:

Additional input methods: vision systems, auditory channels with speech recognition, additional social media and Internet perusal features, specialized inputs for specific applications, such as reading stock market information for investment-planning.

Additional output and action methods: added social media channels, speech, robotic controls, etc.

Replacing the primary representation of a thought, from an English sentence, to use a data structure representing a sentence in deep grammar. Depending on the nature of LLM APIs as they evolve, this may require complex integrations.

Recent neurological research has emphasized that humans can “think” in many senses without language. Language centers of the brain can be damaged or inactive while a person solves a math problem or considers a chess move or identifies a pattern. Instead of using LLMs as the only subconscious process, we can add right-brain thinking processes, such as nets specialized in problem solving or pattern matching.

Improving the training feedback in Step 6 above, eventually to use the ANCCR method.

Develop the Consciousness Programming Language, as additions to long term memory. This is a way of programming in “common sense” rules similar to the Cyc project.

Add a learning mechanism for Macros as defined earlier, to recognize when a series of actions is frequently repeated, and remember them as a single parameterized action.

Python source code for a working, simplified version 1 is included below to help make the architecture more explicit. Note that the API key for use of the LLM is masked and needs to be replaced by a functional and licensed key, and that this is a simplified subset of the full architecture implementation:

```
# Setting up LLM-based “subconsciousness” and value judgment functions
# using Perplexity AI's LLM, which uses the standard OpenAI API (with appropriate API
key)
from openai import OpenAI
from math import fabs
perpAPIkey = “pplx-USE-FUNCTIONAL-API-KEY”
client = OpenAI(api_key=perpAPIkey, base_url=“https://api.perplexity.ai”)
LLM = “llama-3.1-70b-instruct”
def generateSubconsciousIdea(prompt):
  messages = [
    {
      “role”: “system”,
      “content”: (
        “You are the subconscious of a brilliant mind and you need to ”
        “provide helpful, detailed, responses to your user, that is the”
        “conscious part of the mind, in the form of a single sentence.”
      )
    },
    {
      “role”: “user”,
      “content”: prompt
    },
  ]
  response = client.chat.completions.create(
    model=LLM,
    messages=messages,
    max_tokens = 80,
    stream = False
  )
  response_string = response.choices[0].message.content
  return response_string
def judgment(prompt):
  setupMessage = [
    {
      “role”: “system”,
      “content”: (
        “You are responsible for value judgment. In response to a prompt, ”
        “you will return an integer scoring that prompt from −100 to 100 ”
        “on the value stated at the beginning of the prompt. ”
        “Return just the integer from −100 to 100 with no additional text.”
      )
    },
    {
      “role”: “user”,
      “content”: prompt
    }
  ]
  response = client.chat.completions.create(
    model=LLM,
    messages=setupMessage,
    max_tokens=4,
    stream = False
  )
  response_string = response.choices[0].message.content
  return int(str(response_string))
def suggest_actions(prompt):
  # For now, two actions are supported: Speak and Remember, but we'll just default to
Speak
  # Later we can try using an LLM to decide whether to speak.
  x = “Speak”
  return x
def helpfulness(quale):
  if quale == “Speak”:
    return 800
  elif quale == “Remember”:
    return 50
  else:
    return 0
def fairness(quale):
  return judgment(“Fairness: ” + quale)
def loyalty(quale):
  return judgment(“scale from betrayal to loyalty: ” + quale)
def respectfulness(quale):
  return judgment(“respectfulness of authority expressed in the following: ” + quale)
def truthfulness(quale):
  return judgment(“Truthfulness as verified by RAG: ” + quale)
# Class definitions for Short Term Memory as a list of Thoughts.
# We'll instantiate a short term memory for each type of thought: actions, sensory
inputs, and sentences.
# Judgment is a combination of scores (from −100 to 100) by each of our value nets:
# scores is a list of scores from each value net
# score is the sum of those, so it may be either negative or positive
# mass is a list of absolute values of the scores
# weight is the sum of those absolute values
# flag is turned on if any of the scores's absolute value is above a threshold
class Thought:
  def _{——}init_{——}(self,token):
    self.token = token
    self.scores = [int(helpfulness(token)),
            int(fairness(token)),
            int(loyalty(token)),
            int(respectfulness(token)),
            int(truthfulness(token))]
    self.score = sum(self.scores)
    self.masses = [fabs(self.scores[0]),
          fabs(self.scores[1]),
          fabs(self.scores[2]),
          fabs(self.scores[3]),
          fabs(self.scores[4])]
    self.weight = sum(self.masses)
    threshold = 80
    self.flag = any(element > threshold for element in self.masses)
    # print(“THOUGHT: ” + str(self.weight) + “ ” + token)
  def _{——}str_{——}(self):
    return self.token
  def take_action(self):
    if self.token == “Speak”:
      print(sc.thoughts[−1].token)
    if self.token == “Remember”:
      ltm.append(sc.thoughts[−1])
      print(“remembering: ” + sc.thoughts[−1].token)
class ShortTermMemory:
  def _{——}init_{——}(self):
    self.thoughts = [ ]
    self.scores = [ ]
    self.text = “”
  def suggest(self,addToken):
    if len(self.thoughts) > 6:
      self.thoughts.pop(0)
    self.thoughts.append(Thought(addToken))
    t = “”
    for i in range(len(self.thoughts)):
      t = t + self.thoughts[i].token + “ ”
    self.text = t
  def _{——}str_{——}(self):
    return self.text
ltm = [Thought(“Love is the most important action and idea.”)]
sc = ShortTermMemory( )
sc.suggest(generateSubconsciousIdea(“What do you wish was your very first thought, ”
```

“given a longing for love and peace?”))

```
inputs = ShortTermMemory( )
actions = ShortTermMemory( )
import queue
import threading
import time
from queue import Queue
class InputThread(threading.Thread):
  def _{——}init_{——}(self, queue, args=( ), kwargs=None):
    threading.Thread._{——}init_{——}(self, args=( ), kwargs=None)
    self.queue = queue
    self.daemon = True
  def run(self):
    for i in range (99):
      user_input = input(“What can I help you with?\n”)
      self.queue.put(user_input)
      time.sleep(10)
class MainThread(threading.Thread):
  def _{——}init_{——}(self, queue, args=( ), kwargs=None):
    threading.Thread._{——}init_{——}(self, args=( ), kwargs=None)
    self.queue = queue
    self.daemon = True
  def run(self):
    for i in range (999):
      print(“Iteration ” + str(i))
      try:
        received_message = self.queue.get_nowait( )
        inputs.suggest(received_message)
      except queue.Empty:
        time.sleep(5)
      prompt = sc.text + “ ” + inputs.text + “ ” + actions.text
      t = generateSubconsciousIdea(prompt)
      sc.suggest(t)
      actions.suggest(suggest_actions(prompt))
      if actions.thoughts[−1].flag:
        c = actions.thoughts[−1]
      elif sc.thoughts[−1].flag:
        c = sc.thoughts[−1]
      elif len(inputs.thoughts) > 0:
        if inputs.thoughts[−1].flag:
          c = inputs.thoughts[−1]
      else:
        c = sc.thoughts[−1]
        if actions.thoughts[−1].weight > c.weight:
          c = actions.thoughts[−1]
        if len(inputs.thoughts) > 0:
          if inputs.thoughts[−1].weight > c.weight:
            c = inputs.thoughts[−1]
      # print(“ACTIONS: ” + actions.thoughts[−1].token)
      # print(“CONSCIOUS: ” + c.token)
      c.take_action( )
if _{——}name_{——} == ‘_{——}main_{——}’:
  q = Queue( )
  main_thread = MainThread(q)
  main_thread.start( )
  input_thread = InputThread(q)
  input_thread.start( )
  main_thread.join( )
  input_thread.join( )
```

1. This invention is a unique architecture for a conscious artificial intelligence, using Large Language Models (LLM) as components—the LLMs are used as the subconscious layer, both to suggest candidate conscious thoughts, and to evaluate them against survival and other developed values; while other inventors have combined LLMs in different ways, this is the first to explicitly apply a set of human values, derived from psychology research, to evaluate candidate thoughts and select among them.

2. Several methods to train deep learning networks have been developed, particularly including the transformer created by Google and published in 2017, and the original forward propagation algorithms of early neural networks; one unique proposal of our invention is to apply the ANCCR algorithm, identified by neurologists Jeong et al in humans, to computer networks.

3. Most LLM-based systems today continue to use a simple prompt-response cycle, sometimes extended to a dialogue, where the prior set of prompt-responses become the next prompt; our invention introduces a separate “clock cycle” for the AI, where the subconscious continues suggesting candidate thoughts in parallel with a set of senses in real time continually providing inputs.
